(19) United States
(12) Patent Application Publication
(10) Pub. No.: US 2009/0115228 A1
(43) Pub. Date: May 7, 2009

(54) VEHICLE ROOF

(76) Inventors: Alain Leroy, Diessen-Dettenwang (DE); Heinz Pschorn, Dachau (DE)

Correspondence Address: DICKINSON WRIGHT PLLC, 1875 Eye Street, NW, Suite 1200, WASHINGTON, DC, 20006, US

(21) Appl. No.: 11/815,711

(22) PCT Filed: Feb. 7, 2006
(86) PCT No.: PCT/DE06/00202

§ 371 Date: Jun. 11, 2008

(30) Foreign Application Priority Data
Feb. 9, 2005 (DE) 10 2005 005 890.6

(51) Int. Cl. B60R 13/02; B62D 25/06

(52) U.S. Cl. 296/214

(57) ABSTRACT

A vehicle roof is proposed, particularly a passenger automobile roof, comprising a roof outer skin and an internal lining element which serves as a support for functional elements.

According to the invention, the internal lining element is frictionally (by means other than form-interlocking means) connected to the roof outer skin, at least locally, and at least in its edge border regions it is fabricated from a flexible material in such a way that its lateral dimensions are adjustable.

The invention relates to a vehicle roof, particularly a passenger automobile roof, according to the preamble of claim 1.

Such a vehicle roof is known from U.S. Pat. No. 5,825,096, and comprises a roof internal lining element which bears, in its border region directed toward the windshield, a support element for electrical devices. The electrical devices contemplated consist of, e.g., an antenna, a control unit, or the like. The internal lining element of this roof module is stiff.

A shape retaining or rigid internal lining element is mounted on a vehicle having a front and rear windshield border, wherewith it is passed rearwardly (or forwardly) through the frame provided for said windshields, into the interior space of the vehicle cabin, and then is fixed from below via hand grip supports and sun visor supports. In the mounted position the internal lining element contacts the windshield border element.

The roof of a passenger automobile may also be in the form of a [(e.g. prefabricated)] roof module which is attached to the frame during the vehicle assembly process. The roof module may be completely pre-configured, and may comprise a roof outer skin, an internal lining element, and various functional elements. These functional elements may be, e.g., a sliding sunroof, a light, an antenna, or the like.

A roof module for a motor vehicle is disclosed in DE 20311915 U1 [(Gebrauchsmuster)], which module has a roof outer skin, an internal layer, and an intermediate layer, with the outer skin and internal layer being interconnected. The internal layer forms the cabin internal roof surface of the vehicle. The intermediate layer is comprised of fiber-reinforced polyurethane foam. To aid in assembly, the roof module has swingable side strips of (or for) the cabin internal roof surface. Nothing is mentioned about integration of functional elements.

The underlying problem of the present invention was to devise a vehicle roof which can be fabricated in the form of a roof module, having an internal lining element which bears functional elements and which can be mounted as a complete module from above onto a body frame or the like of a vehicle.

This problem is solved by a vehicle roof having the features set forth in claim 1.

The inventive vehicle roof is comprised of at least one roof outer skin and a module having an internal lining element, in which module the internal lining element is frictionally (by means other than form-interlocking means) connected to the roof outer skin, at least locally, and at least in its edge border regions it is fabricated from a flexible material in such a way that its lateral dimensions are adjustable (may be reduced). Hereby it is possible to provide a roof module, comprised of a roof outer skin and an internal lining element connected to said skin, which internal lining element serves as a support for functional elements, which roof module in its finally configured state can be mounted from above onto a vehicle frame, wherewith the internal lining element, in a simple, easy, and optimized manner, can be introduced from above into the interior of the vehicle cabin, employing the so-called “top-load” method, e.g., having a peripheral fold or bead, whereafter said internal lining element can be fixed into its mounting position from below, with the use of suitable fixing means, to serve as the cabin internal roof surface. In an example of such an installation, such an internal lining element serving as a cabin internal roof surface may be swung into place against windshield border elements and/or against roof lateral frame regions. The fixing of the internal lining element in its mounting position is accomplished, e.g., via sun visor supports, hand grips [or hand grip supports], or catch elements provided on the interior side of the roof outer skin. The internal lining element may be fixed to body frame elements, such as regions of the roof frame, or to the roof outer skin.

The term “roof outer skin” is intended in its widest sense. The roof out skin may comprise a single shell (curved plate) or a plurality of shells, e.g. an outer shell which forms the visible surface of the vehicle roof and an inner supporting shell which confers rigidity on the vehicle roof.

The term “functional elements” should be understood to mean structural elements or groups of structural elements associated with, e.g., electrical and/or mechanical means for the vehicle, e.g. interior lighting means, an antenna, or a slidable sunroof. The functional elements may particularly be disposed on the upper side [sic] of the internal lining element.

The flexible material of which the internal lining element is comprised allows it to be fixed in a recess or groove of the vehicle in an undercut or similarly engaging (interlocking) manner. The term “flexible material” should be understood to encompass a material which is foldable or bendable.

The inventively configured vehicle roof has an engineering design such that it may be simply and easily mounted from above as a single subassembly comprised of the roof outer skin and the internal lining element, wherewith in the event it becomes necessary or desirable to de-install the vehicle roof the internal lining element can remain [in place] undamaged. Vehicle manufacturing logistics are facilitated by the ability to pre-assemble the complete vehicle roof.

According to a preferred embodiment of the inventive vehicle roof, the internal lining element is bonded to the roof outer skin by applying the internal lining element as a foam, wherewith in this case the internal lining element is comprised of a foam material, at least in part of its extent. The manufacture of the vehicle roof may thus be carried out essentially in a molding device (or other forming device).

According to an alternative embodiment, the internal lining element is bonded to the roof outer skin by adhesive means. In manufacturing such a vehicle roof, the roof outer skin and internal lining element may be fabricated in separate tool devices, and the required functional elements may be provided then or thereafter, following which the roof outer skin and internal lining element may then be joined.

In order to enable separate replacement of the internal lining element, the inventive vehicle roof may be configured such that the internal lining element is removably joined to the roof outer skin.

In particular [sic], in the case of fabrication of the internal lining element from a material such as soft polyurethane foam, the internal lining element may have a washable surface, which is advantageous for hygienic reasons.

In order to enjoy the desired flexibility characteristics, preferably the internal lining element may be fabricated of soft foam material, particularly a soft polyurethane foam.

In order to be able to integrate functional regions, particularly functional regions such as head impact elements, directly into the internal lining element, the internal lining element may be fabricated with zones of different hardness. The hardness can be controlled via the foam thickness. This makes unnecessary the former practice wherein it was necessary to separately install a head impact element as a passive safety device; thus with the aid of the invention the fabrication costs of the vehicle roof can be reduced.

As an example, to produce a contoured surface on the face of the internal lining element directed toward interior cabin space, the internal lining element may be provided with zones of different thickness.

The internal lining element may also be provided with surface regions which have different colors, structures, or other properties.

In preferred embodiments of the inventive vehicle roof, electrical devices are provided, such as interior lighting elements, conductor conduits (or conductor paths) for interior lighting elements, and antenna components; and/or channels for air heating, air conditioning, and ventilation are provided which preferably are connected to openings to the cabin interior space. The functional elements may also comprise airbag components. The airbag components may particularly comprise components associated with a front airbag for the benefit of occupants of the rear seat. The functional elements may also comprise mechanical components, e.g. components associated with a roof opening system such as a sliding sunroof.

The internal lining element may also have integrated into it means for aiding down-swinging of a device associated with a head airbag, wherewith the airbag may be activated when the movement of said means is decelarated [sic]. This can be realized by zonal control of the properties of the material.

If the inventive vehicle roof is provided with a sliding sunroof or a sliding and shifting (or swinging) sunroof, openings or slits may be provided in the roof outer skin and the internal lining element, corresponding to a cover element for selective opening or partial opening of a roof opening, wherewith the required mechanical and electrical components for such a sunroof apparatus may be in or on the internal lining element and the roof outer skin.

Thus, fundamentally, a broad selection of components can be provided in or on the internal lining element, which components can have or can facilitate numerous functionalities.

The material of the internal lining element may itself have a decorative surface, so that the visible surface of the internal lining element, as to its color, surface characteristics, and structure, may be provided directly (inherently), without additional operations or the use of additional tools. When the internal lining element provides an inherent one-piece decorative surface in this way, particularly in the case of a vehicle roof with a roof opening system, one avoids wastage (from cuttings) from the provision of a separate decorative lining, which formerly was required. Also the costs of applying the decorative lining are eliminated, and the costs of said lining (sheet, film, etc.) itself.

Alternatively, one may supply the decorative surface by means of an applied layer, employing a suitable application apparatus during the fabrication of the internal lining element.

Additional advantages and advantageous refinements and specific embodiments of the invention are disclosed in the Specification, drawings, and claims (or are suggested and are readily inferrable).

An exemplary embodiment of an inventive vehicle roof is illustrated schematically in the drawings, and will be described in more detail hereinbelow.

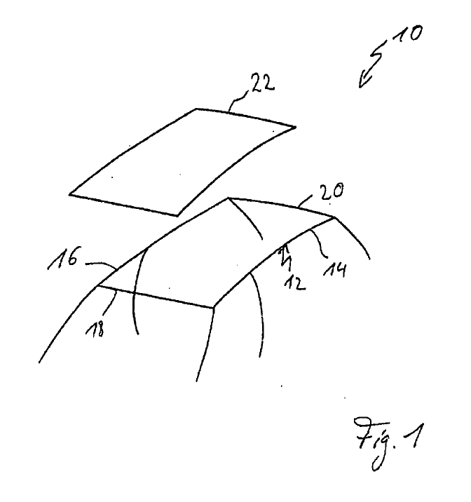

FIG. 1 is a schematic view of the roof region of a passenger automobile having a roof module;

FIG. 2 is a schematic longitudinal cross section through the roof region, in the course of the mounting of the roof module;

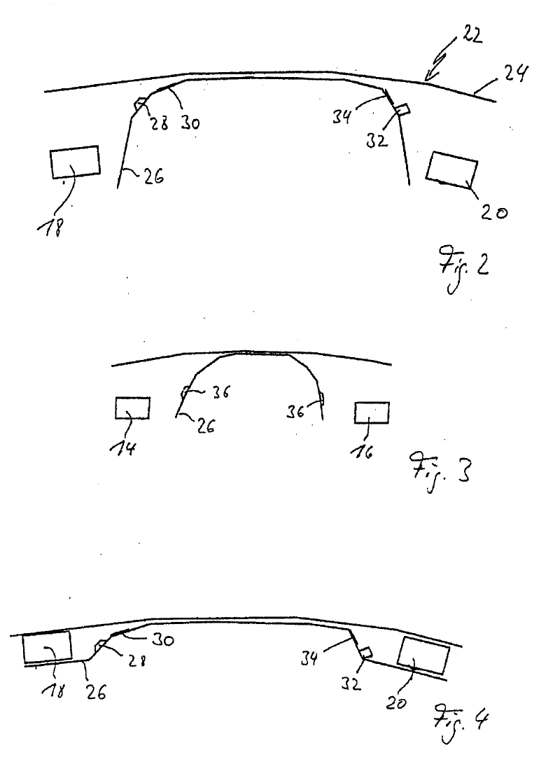

FIG. 3 is a schematic transverse cross section through the roof region, in the course of the mounting of the roof module; and

FIG. 4 is a longitudinal cross section corresponding to FIG. 2, with the roof module having been mounted.

FIG. 1 illustrates the roof region of a passenger automobile 10. The roof region has a roof frame 12, comprised of lateral frame regions (14, 16) extending in the longitudinal direction of the vehicle, a front windshield border element 18, and a rear windshield border element 20. This frame 12 serves to accommodate an inventively configured roof module 22 which undergoes pre-assembly and shaping into a desired curved surface.

As may be seen from FIGS. 2-4, the roof module 22 has a multilayer roof outer skin 24 and an internal lining element 26 which latter is applied to a central region of the roof outer skin 24 as a foam (or by means of a foam). The internal lining element 26, which in the installed state forms the cabin roof surface of the vehicle, is comprised of soft polyurethane foam material. The roof outer skin 24 has a rigid glass-fiber-reinforced polyurethane layer, produced, e.g., by the LFI (long fiber injection) method, and further has a visible layer comprised of a plastic film or sheet comprised of, e.g., ABS [polymer].

The internal lining element 26 comprised of soft polyurethane foam is bendable and flexible, so that when the roof module 22 is being mounted on the roof frame 12 the lining element 26 with downward hanging border regions can be passed through the opening formed by the roof frame 12 and into the interior cabin space of the passenger automobile 10. The lateral dimensions of the internal lining element 26 can thus be reduced, and can be set such that said lining element can be readily brought past the roof frame 12, being moved from above through the opening formed by said frame at the windshield border elements 18 and 20 and the lateral frame regions 14 and 16. If thereafter the roof outer skin 24 is fixed to the roof frame 12, e.g. by means of a bead of adhesive material, the internal lining element 26 becomes [simultaneously therewith] fixed (at its side regions) to the lateral frame regions (14; 16) and (at its front and rear regions) to the front and rear windshield border elements (18; 20), wherewith its front and rear regions come to contact the front and rear windshield borders (18; 20) on their lower surfaces, and its lateral regions come to engage grooves (not illustrated) which are formed in the regions of the lateral frame regions (14; 16).

The internal lining element 26 forms a support for functional elements, e.g. (in the present example) a reading light 28 and associated wiring conduits (or tracks) 30, in the region of the front windshield border element 18, and an antenna 32 with associated wiring conduits (or tracks) 34.

The internal lining element 26 has zones of different hardness, in particular head impact zones 36 are provided which have a greater Shore hardness than the ordinary regions of the internal lining element 26. In the region of the head impact zones 36, the material of the internal lining element 26 is thicker than in neighboring regions.

Also, the internal lining element 26 forms the visible surface bounding the passenger cabin, wherewith it is unnecessary to provide a supplementary film or sheet of additional material for this purpose. The polyurethane foam material employed is of a washable type.

### LIST OF REFERENCE NUMERALS

10 passenger automobile.

12 roof frame.

14 lateral frame region.

16 lateral frame region.

18 front windshield border element.

20 rear windshield border element.

22 roof module.

24 roof outer skin.

26 internal lining element.

28 reading light.

30 wiring conduit (or track).

32 antenna.

34 wiring conduit (or track).

36 head impact zone.

1. A vehicle roof, particularly a passenger automobile roof, comprising a roof outer skin and an internal lining element which serves as a support for functional elements; characterized in that the internal lining element is frictionally (by means other than form-interlocking means) connected to the roof outer skin, at least locally, and at least in its edge border regions it is fabricated from a flexible material in such a way that its lateral dimensions are adjustable.

2. A vehicle roof of claim 1; characterized in that the internal lining element is applied as a foam which is bound to the roof outer skin.

3. A vehicle roof of claim 1; characterized in that the internal lining element is bound to the roof outer skin by adhesive means.

4. A vehicle roof of claim 1; characterized in that the internal lining element is removably fixed to the roof outer skin.

5. A vehicle roof of claim 1; characterized in that the internal lining element is formed so as to be foldable or bendable.

6. A vehicle roof of claim 1; characterized in that the internal lining element is fabricated from a soft foam material, e.g. a soft polyurethane foam.

7. A vehicle roof of claim 1; characterized in that the internal lining element is formed with zones of different hardness.

8. A vehicle roof of claim 1; characterized in that head impact elements are integrated into the internal lining element.

9. A vehicle roof of claim 1; characterized in that the internal lining element has zones of different thickness.

10. A vehicle roof of claim 1; characterized in that the functional elements comprise electrical devices.

11. A vehicle roof of claim 1; characterized in that the functional elements comprise air heating, air conditioning, and/or ventilation channels, preferably provided with openings to the interior of the passenger cabin.

12. A vehicle roof of claim 1; characterized in that the functional elements comprise airbag components.

13. A vehicle roof of claim 1; characterized in that the internal lining element has a decorative surface.

14. A vehicle roof of claim 13; characterized in that the decorative surface is formed from (or comprised of) the inherent material of the internal lining element.
